(19) United States
(12) Patent Application Publication
(10) Pub. No.: US 2007/0177061 A1
(43) Pub. Date: Aug. 2, 2007

(54) Digital broadcast receiver

(75) Inventor: Koji Miyazaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/700,942

(22) Filed: Feb. 1, 2007

(30) Foreign Application Priority Data
Feb. 2, 2006 (JP) P2006-025787

(51) Int. Cl. H04N 5/268

(52) U.S. Cl. 348/725; 348/706

(57) ABSTRACT

According to one embodiment, there is provided a digital broadcast receiver including: a tuner that receives an analog broadcast and a digital broadcast including time information; a clock section that measures a time; a select section that selects one of the analog broadcast and the digital broadcast to be output when the digital broadcast receiver is turned on; a time information acquisition section that controls the tuner to receive a channel of the digital broadcast to acquire the time information when the select section selects the analog broadcast; a control section that controls the tuner to receive and output the analog broadcast after the time information acquisition section acquires the time information; and a time adjust section that adjusts the time measured in the clock section by the acquired time information.

### CROSS-REFERENCE TO RELATED APPLICATIONS

This application is based upon and claims the benefit of priority from Japanese Patent Application No. 2006-025787, filed Feb. 2, 2006, the entire contents of which are incorporated herein by reference.

### BACKGROUND

1. Field

One embodiment of the invention relates to a digital broadcast receiver, and more particularly, to a digital broadcast receiver that acquires time information from a broadcast wave to adjust an internal clock.

2. Description of the Related Art

A digital broadcast receiver that acquires time information from a broadcast wave of a digital broadcast to adjust an internal clock is disclosed by, for example, Japanese Patent Application Publications (KOKAI) No. 2005-303799 and No. 2003-279677. The digital broadcast receiver can be equipped with a programmed recording function that acquires information about an electronic program guide from a broadcast wave and utilize the electronic program guide.

In relation to a digital broadcast receiver, cost cutting and miniaturization of a product are in progress. Some digital broadcast receivers are equipped with all-in-one tuners that are compatible with both a digital broadcast and an analog broadcast by sharing components and can receive a broadcast wave of one of the broadcast system.

However, for example, when the analog broadcast is watched at turning on the digital broadcast receiver, the digital broadcast receiver may fail to acquire current time information from a digital broadcast wave and may fail to set a correct time in the internal clock. When the correct time is not set in the internal clock, the digital broadcast receiver equipped with, e.g., the programmed recording function, may fail to perform programmed recording correctly.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram for describing the configuration of a digital broadcast receiver according to a first embodiment of the present invention;

FIGS. 2A and 2B are exemplary views showing the flow of a signal achieved when a digital terrestrial broadcast is watched by a broadcast receiver equipped with an analog terrestrial broadcast tuner and a separate digital terrestrial broadcast tuner;

FIG. 3 is an exemplary flowchart for describing operation of time information acquisition processing performed when the digital broadcast receiver is turned on;

FIG. 4 is an exemplary block diagram for describing the configuration of the digital broadcast receiver according to a second embodiment of the present invention;

FIGS. 5A and 5B are exemplary views showing the flow of a signal achieved when a digital terrestrial broadcast is watched by a broadcast receiver equipped with a tuner into which an analog terrestrial broadcast tuner and a digital terrestrial broadcast tuner are integrated;

FIG. 6 is an exemplary flowchart for describing operation of time information acquisition processing performed when the digital broadcast receiver is turned on; and

FIGS. 7A to 7D are exemplary views showing an example screen to be displayed.

### DETAILED DESCRIPTION

Various embodiments according to the invention will be described hereinafter with reference to the accompanying drawings. In general, according to one embodiment of the invention, there is provided a digital broadcast receiver including: a tuner that receives an analog broadcast and a digital broadcast including time information; a clock section that measures a time; a select section that selects one of the analog broadcast and the digital broadcast to be output when the digital broadcast receiver is turned on; a time information acquisition section that controls the tuner to receive a digital broadcast to acquire the time information when the select section selects the analog broadcast; a control section that controls the tuner to receive and output the analog broadcast after the time information acquisition section acquires the time information; and a time adjust section that adjusts the time measured in the clock section by the acquired time information.

### First Embodiment

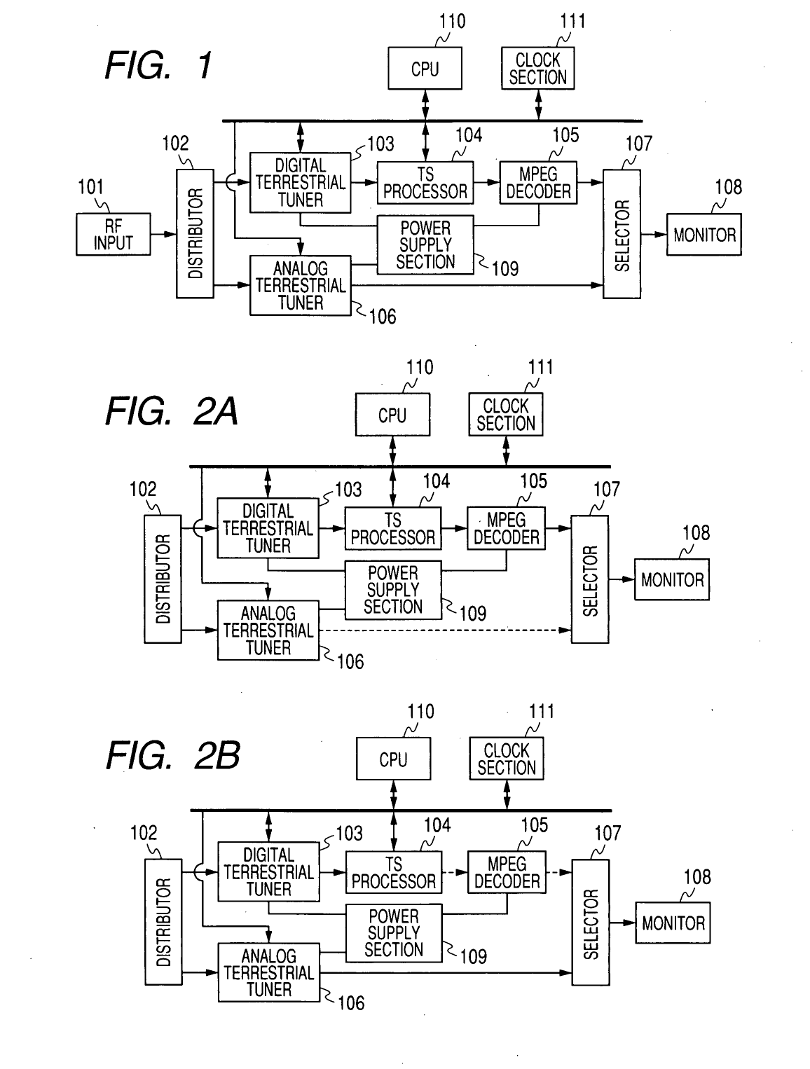

FIG. 1 is an exemplary view showing the configuration of a digital broadcast receiver according to a first embodiment of the present invention. FIG. 1 depicts an example digital broadcast receiver that does not use an all-in-one tuner and is separately equipped with an analog broadcast tuner and a digital broadcast tuner.

In FIG. 1, a digital broadcast receiver includes an RF input section 101, a distributor 102, a digital terrestrial tuner 103, a TS processor 104, an MPEG decoder 105, an analog terrestrial tuner 106, a selector 107, a monitor 108, a CPU 110, clock section 111 and a power supply section 109.

The RF input section 101 outputs to the distributor 102 an RF signal input from an antenna.

The distributor 102 distributes the RF signal input via the RF input terminal 101 to the digital terrestrial tuner 103 and the analog terrestrial tuner 106.

The digital terrestrial tuner 103 demodulates the digital terrestrial broadcast to thus obtain a TS (Transport Stream) and outputs the TS to the TS processor 104.

The TS processor 104 extracts a packet pertaining to a selected program from the TS, and outputs the packet to the MPEG decoder 105.

The MPEG decoder 105 subjects the packet pertaining to the selected program to MPEG decoding, and outputs decoded video and audio signals to the selector 107. Further, the MPEG decoder 105 is supplied with power from power supply section 109 only while the digital terrestrial broadcast is received.

The analog terrestrial tuner 106 that receives an analog terrestrial broadcast demodulates a selected program and outputs the demodulated video and audio signals to the selector 107. The analog terrestrial tuner 106 is supplied with power from the power supply section 109 only while an analog terrestrial broadcast is received.

The selector 107 selects the video and audio signals output from the MPEG decoder 105 while a digital broadcast is watched; selects the video and audio signals output from the analog terrestrial tuner 106 while an analog broadcast is received; and outputs the selected video and audio signals to the monitor 108.

The CPU 110 acquires current time information from the digital terrestrial broadcast, regardless of whether the selected program is a program of the digital terrestrial broadcast or a program of the analog terrestrial broadcast.

(While a Digital Broadcast is Received)

FIG. 2A shows the exemplary flow of a signal achieved when the digital broadcast receiver receives a digital broadcast.

As shown in FIG. 2A, while a digital broadcast is received, the CPU 110 acquires current time information sent from the TS processor 104 through the digital broadcast wave, and synchronizes the time (adjusts the time) of the clock section 111.

While the digital broadcast is received, the analog terrestrial tuner 106 is not supplied with power, and hence does not output any demodulated signal. In FIG. 2A, a broken line depicts no flow of a signal.

(While an Analog Broadcast is Received)

FIG. 2B shows the exemplary flow of a signal achieved when the digital broadcast receiver receives an analog broadcast.

As shown in FIG. 2B, while an analog broadcast is received, the digital terrestrial tuner 103 and the TS processor 104 are also supplied with power. The CPU 110 acquires the current time information, which has been transmitted along with a digital broadcast wave, from the TS processor 104, and adjusts the time of the clock section 111.

While the analog broadcast is received, the power supply to the MPEG decoder 105 is turned off, and hence the MPEG decoder 105 does not output a decoded signal. In FIG. 2B, a broken line depicts the flow of no signal.

(Operation)

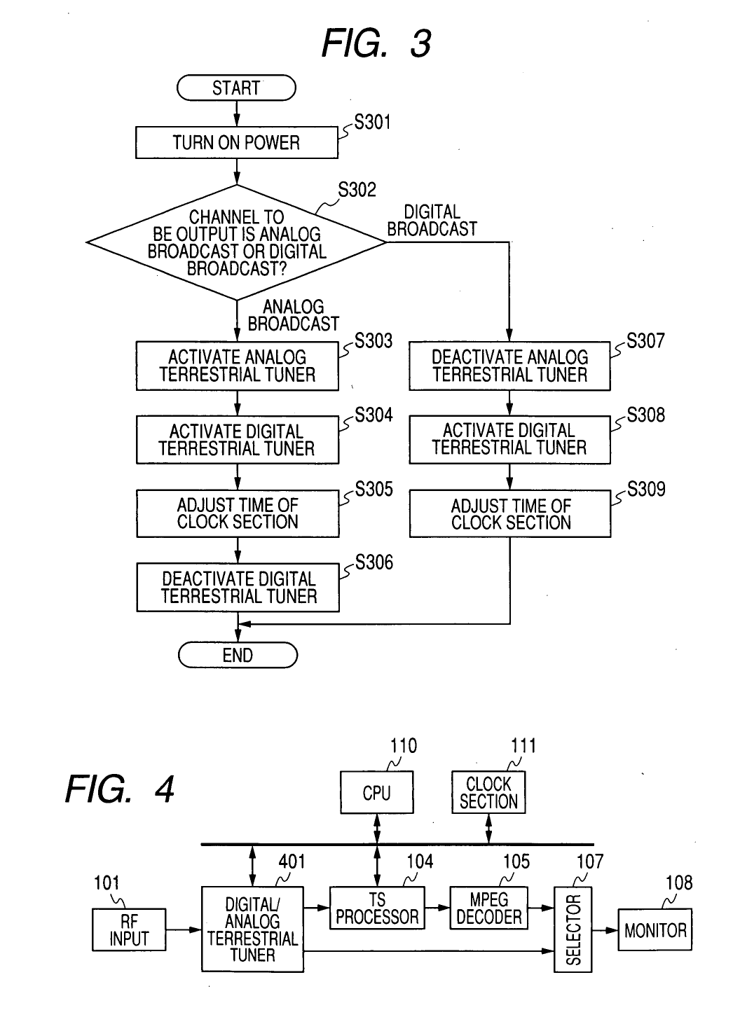

Operation of time acquisition processing performed when the digital broadcast receiver is turned on will now be described with reference to a flowchart shown in FIG. 3. This operation is controlled by the CPU 110.

Block S301: The digital broadcast receiver is turned on.

Block S302: A channel to be output at turning on the digital broadcast receiver is selected by a default channel function or a last channel function. The processing proceeds to Block S303 when the selected channel is a channel for the analog broadcast. The processing proceeds to Block S307 when the selected channel is a channel for the digital broadcast.

Block S303: The analog terrestrial tuner 106 is activated, and the processing proceeds to Block S304.

Block S304: The digital terrestrial tuner 103 is activated, and the processing proceeds to Block S305.

Block S305: The time of the clock section 111 is adjusted when the time information has been acquired by the digital terrestrial tuner 103, and the processing proceeds to Block S306.

Block S306: The power supply to the digital terrestrial tuner 103 by the power supply section 109 is turned off, and the operation of time acquisition processing ends.

Block S307: The analog terrestrial tuner 106 is deactivated, and the processing proceeds to Block S308.

Block S308: The digital terrestrial tuner 103 is activated, and the processing proceeds to Block S309.

Block S309: The time of the clock section 111 is adjusted when the time information has been acquired by the digital terrestrial tuner 103 and the operation of time acquisition processing ends.

It is no matter that the clock section 111 is provided with a battery backup or not. When the clock section 111 is provided with the battery backup, the clock section can be adjusted with a more correct time. When the clock section 111 is not provided with the battery backup, the clock section can be newly set.

Even when the digital broadcast receiver is programmed to receive a program of an analog broadcast at turning on, an analog broadcast is received after the digital broadcast tuner has once acquired time information at turning on and adjusted the time. Accordingly, the time information in the digital broadcast receiver can always be maintained correct at turning on.

As has been described above, according to the first embodiment of the present invention, the time information in the digital broadcast receiver can be maintained correct.

### Second Embodiment

FIG. 4 is a view showing the configuration of a digital broadcast receiver according to a second embodiment of the present invention. FIG. 4 shows an example broadcast receiver equipped with a single all-in-one tuner into which an analog broadcast tuner and a digital broadcast tuner are integrated. Those elements that are the same as those shown in FIG. 1 are assigned the same reference numerals.

In FIG. 4, the digital broadcast receiver includes the RF input section 101; a digital/analog terrestrial tuner 401; the TS processor 104; the MPEG decoder 105; the selector 107; the monitor 108; the CPU 110; and the clock section 111.

The digital/analog terrestrial tuner 401 is the all-in-one tuner into which the analog broadcast tuner and the digital broadcast tuner are integrated.

(While a Digital Broadcast is Received)

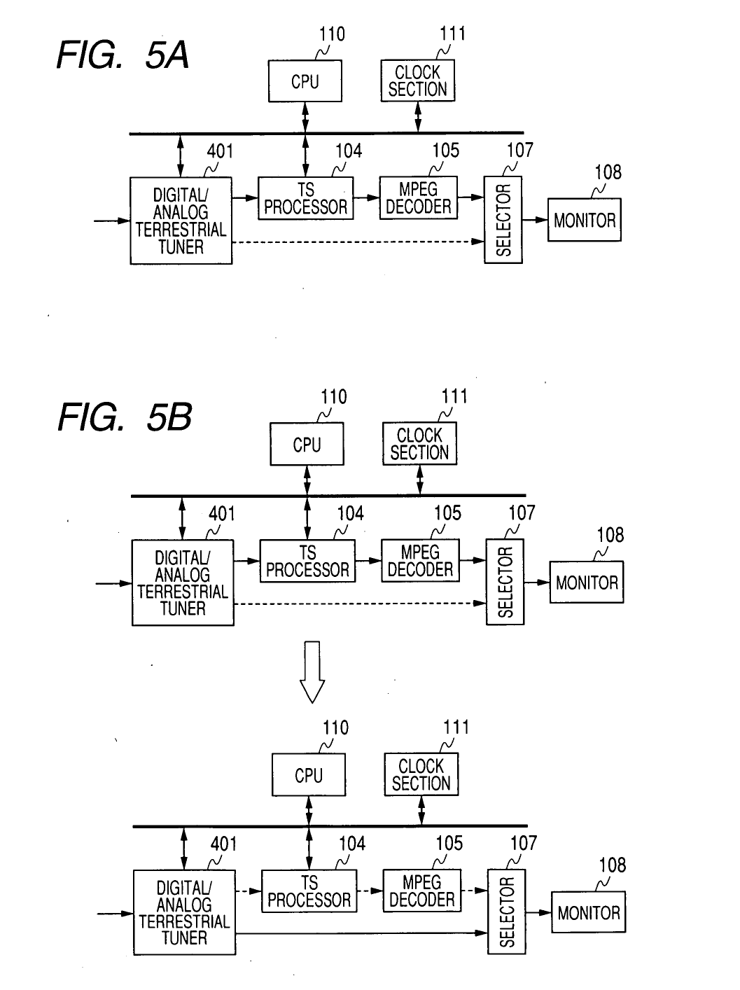

FIG. 5A shows the exemplary flow of a signal achieved when the digital broadcast receiver receives a digital broadcast.

As shown in FIG. 5A, while a digital broadcast is received, the CPU 110 acquires the current time information, which has been transmitted along with the broadcast wave, from the TS processor 104, and adjusts the time of the clock section 111 (synchronizes the time of the clock section with the current time).

While a digital broadcast is received, the digital/analog terrestrial tuner 401 does not output a signal generated by demodulating the analog broadcast to the selector 107. In FIG. 5A, a broken line depicts the flow of no signal.

(While an Analog Broadcast is Received)

FIG. 5B shows the exemplary flow of a signal achieved when the digital broadcast receiver receives an analog broadcast.

As shown in FIG. 5B, while an analog broadcast is to be received, the CPU 110 acquires the current time information that has been transmitted along with the broadcast wave, from the TS processor 104, and adjusts the time of the clock section 111.

After the adjustment of the time, the digital/analog terrestrial tuner 401 outputs the signal generated by demodulating the analog broadcast to the selector 107.

(Operation)

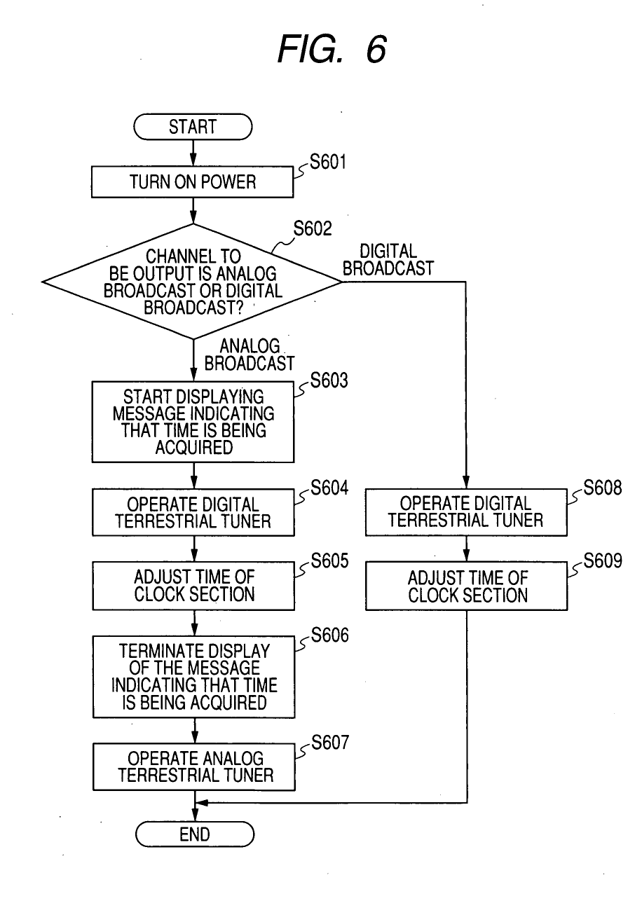

operation of time acquisition processing performed when power of the digital broadcast receiver is turned on will now be described with reference to a flowchart shown in FIG. 6. This operation is controlled by the CPU 110.

Block S601: The digital broadcast receiver is turned on.

Block S602: A channel to be received at turning on the digital broadcast receiver is selected by a default channel function or a last channel function. The processing proceeds to Block S603 when the channel to be received is a channel for the analog broadcast. The processing proceeds to Block S608 when the channel to be received is a channel for the digital broadcast.

Block S603: The monitor 108 is started to display a message indicating that time information is now being acquired, by, for example, an OSD function.

Block S604: The digital terrestrial tuner is activated, and the processing proceeds to Block S605.

Block S605: The time of the clock section 111 is adjusted when the time information has been acquired by the digital terrestrial tuner and the processing proceeds to Block S606.

Block S606: The monitor 108 is stopped displaying the message indicating that time information is now being acquired, by, for example, the OSD function. The processing proceeds to Block S607.

Block S607: The analog terrestrial tuner is activated, and the operation of time acquisition processing ends.

Block S608: The digital terrestrial tuner is activated, and the processing proceeds to Block S609.

Block S609: The time of the clock section 111 is adjusted when the time information has been acquired by the digital terrestrial tuner and the operation of time acquisition processing ends.

It is no matter that the clock section 111 is provided with a battery backup or not. When the clock section 111 is provided with the battery backup, the clock section can be adjusted with a more correct time. When the clock section 111 is not provided with the battery backup, the clock section can be newly set.

Even when the digital broadcast receiver is programmed to receive a program of an analog broadcast at turning on, an analog broadcast is received after the digital broadcast tuner has once acquired time information at turning on and adjusted the time. Accordingly, the time information in the digital broadcast receiver can always be maintained correct at turning on.

As has been described above, according to the present invention the time information about the digital broadcast receiver can be maintained correct.

(Example Display Screen)

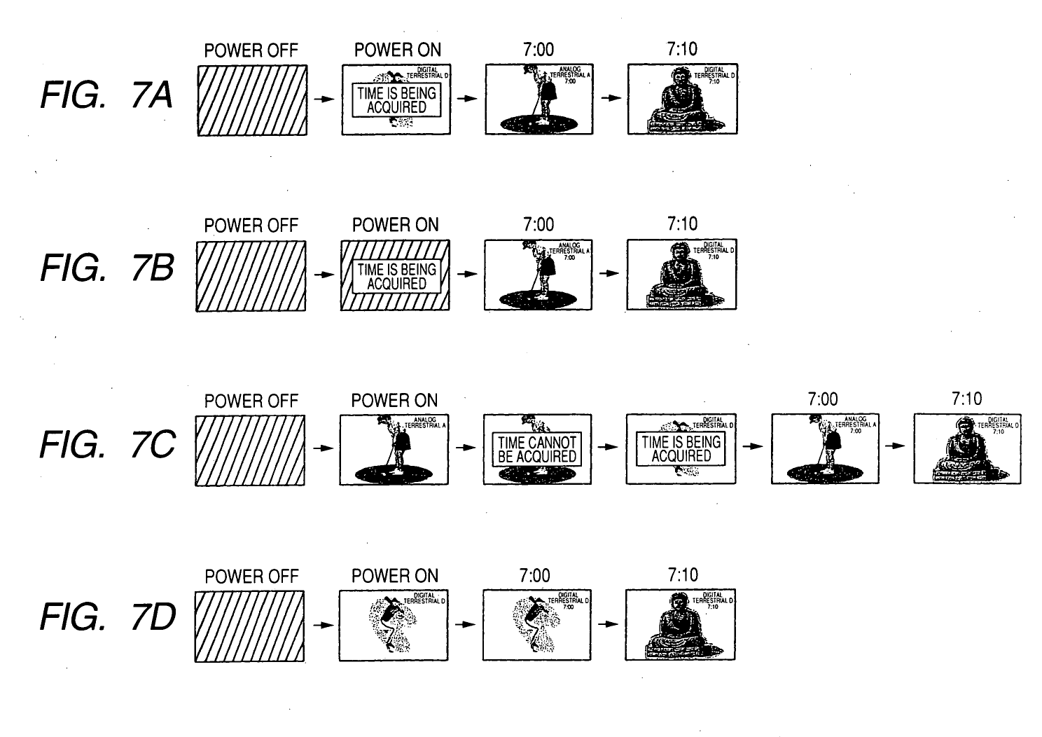

FIGS. 7A to 7D show exemplary display screens appearing when the broadcast receiver equipped with the all-in-one tuner performs time information acquisition processing such as that described in connection with the second embodiment.

1. When the broadcast receiver is not equipped with a clock device having a battery backup, effective current time information is not present in the digital broadcast receiver while power of the broadcast receiver is turned off.

2. The broadcast receiver has program storage function, and recording of a digital terrestrial broadcast is programmed to start from 7:10.

3. The last channel selected when the digital broadcast receiver is turned off previous time is a channel for the analog terrestrial broadcast, and the last channel is stored in nonvolatile memory.

FIG. 7A is a view that describes, by use of a display screen, a series of operations achieved when the time information acquisition processing according to the second embodiment is performed at turning on.

When the digital broadcast receiver is turned on, a digital terrestrial broadcast is temporarily received in order to acquire time information.

At this time, a program of a baseball game, which is not the stored last channel and is for a digital terrestrial broadcast, appears on the screen, and a message indicating that time is now being acquired is displayed on the screen by the OSD function. If possible, by the OSD function, there is displayed a message indicating that switching is automatically made to, e.g., the first channel which is the stored last channel from the present channel after the adjustment of the time. When tuning operation is performed before the time information can be acquired from the digital terrestrial broadcast, a message is displayed by the OSD function to limit operations.

After the current time is acquired from the digital terrestrial broadcast, the tuning state is switched to the analog terrestrial broadcast for the stored last channel, to display a video and an audio on the screen. The thus-acquired current time is continuously counted in a free-running manner by a clock signal from the CPU. When the time has come to 7:10 when programmed operation is to be performed, programmed recording is executed.

FIG. 7B is a view that describes, by use of a display screen, a series of operations achieved when the time information acquisition processing according to the second embodiment is performed at turning on.

In FIG. 7A, a digital broadcast is displayed at first. However, in FIG. 7B, the last channel for the analog terrestrial broadcast is not displayed at first. Therefore, neither video nor audio is provided, and instead, a message indicating the current state is displayed by the OSD function. In other respects, FIG. 7B is the same as FIG. 7A.

Thus, the stored last channel can be displayed on the monitor 108 at first.

FIG. 7C is a view that describes operations achieved when the time information acquisition processing according to the second embodiment is not performed at turning on, and when a time is adjusted by user's tuning operation.

The last channel for the analog terrestrial broadcast is received and displayed on the screen when the digital broadcast receiver is turned on. Also, a message indicating that time information cannot be acquired is displayed on the screen. According to this message, when the user selects the digital terrestrial broadcast by his operation, the current time information is acquired. The thus-acquired current time is continuously counted in a self-running manner by a clock signal from the CPU. Even when the user watches TV after having switched the channel to the analog terrestrial broadcast after the time information is acquired, programmed recording is performed when the time has come to 7:10 when programmed operation is to be performed.

FIG. 7D differs from the examples shown in FIGS. 7A to 7C in that the last channel is the digital terrestrial broadcast, and shows an example operation performed in that case.

Namely, the last channel for the digital terrestrial broadcast is received and displayed on the screen when the digital broadcast receiver is turned on.

In this case, since current time information can be acquired from the digital terrestrial broadcast, a message displayed by the OSD function does not appear by only operation of turning on. However, when a channel for the analog terrestrial broadcast is selected before time information can be acquired from the digital terrestrial broadcast, the message is displayed by the OSD function to limit operation. Since the current time can be acquired, programmed recording is performed when the time has come to 7:10 when programmed operation is to be performed.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

For example, the time information acquisition processing may be performed only when a programmed recording of a broadcast is set.

For example, the time information may be acquired only when an analog broadcast is to be displayed on the screen when the digital broadcast receiver is turned on.

What is claimed is:

1. A digital broadcast receiver comprising:
a tuner that receives an analog broadcast and a digital broadcast, the digital broadcast including time information;
a clock section that measures a time;
a select section that selects one of the analog broadcast and the digital broadcast to be output when the digital broadcast receiver is turned on;
a time information acquisition section that controls the tuner to receive a channel of the digital broadcast to acquire the time information when the select section selects the analog broadcast;
a control section that controls the tuner to receive and output the analog broadcast after the time information acquisition section acquires the time information; and
a time adjust section that adjusts the time measured in the clock section by the acquired time information.

2. The digital broadcast receiver according to claim 1, further comprising a notification section that outputs a signal indicating that the time is adjusted while at least a part of a time period from a time when the digital broadcast receiver is turned on to a time when the time information acquisition section has finished to acquire the time information.

3. The digital broadcast receiver according to claim 1, further comprising a prohibition section that prohibits switching a channel during a time period from a time when the digital broadcast receiver is turned on to a time when the control section starts to receive the analog broadcast.

4. The digital broadcast receiver according to claim 1, further comprising a storage that stores a last channel watched when the digital broadcast receiver is turned off previous time,
wherein the select section selects according to the last channel stored in the storage.

5. The digital broadcast receiver according to claim 1, further comprising:
a programmed recording setting section that sets programmed recording of a preset broadcast; and
a recording section that records the preset broadcast received by the tuner on a recording medium according to the time measured in the clock section,
wherein the time adjust section adjusts the time measured in the clock section only when the programmed recording is set.

6. A digital broadcast receiver comprising:
an analog tuner that receives an analog broadcast;
a digital tuner that receives a digital broadcast including time information;
a power supply section that respectively provides power supply to the analog tuner and the digital tuner;
a clock section that measures a time;
a select section that selects one of the analog broadcast and the digital broadcast to be output when the digital broadcast receiver is turned on;
a time information acquisition section that controls the digital tuner to receive a channel of the digital broadcast to acquire the time information when the select section selects the analog broadcast to be output;
a control section that turns off the power supply to the digital tuner after the time information acquisition section acquires the time information and turns on the power supply to the analog tuner to receive and output the analog broadcast; and
a time adjust section that adjusts the time measured in the clock section by the acquired time information.

7. The digital broadcast receiver according to claim 6, further comprising a notification section that outputs a signal indicating that the time is adjusted while at least for a part of a time period from a time when the digital broadcast receiver is turned on to a time when the time information acquisition section has finished to acquire the time information.

8. The digital broadcast receiver according to claim 6, further comprising a prohibition section that prohibits switching a channel during a time period from a time when the digital broadcast receiver is turned on to a time when the control section turns on the analog tuner to receive the analog broadcast.

9. The digital broadcast receiver according to claim 6, further comprising a storage that stores a last channel watched when the digital broadcast receiver is turned of f previous time,
wherein the select section selects according to the last channel stored in the storage.

10. The digital broadcast receiver according to claim 6, further comprising:
a programmed recording setting section that sets programmed recording of a preset broadcast; and
a recording section that records the preset broadcast received by the digital tuner or the analog tuner on a recording medium according to the time measured in the clock section,
wherein the time adjust section adjusts the time measured in the clock section only when the programmed recording is set.
